(19) United States
(12) Patent Application Publication
(10) Pub. No.: US 2008/0048881 A1
(43) Pub. Date: Feb. 28, 2008

(54) Technique and Apparatus to Track and Position Electromagnetic Receivers

(75) Inventors: Kambiz A. Safinya, Garches (FR); Erik Vigen, Honefoss (NO)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 11/466,972

(22) Filed: Aug. 24, 2006

(51) Int. Cl. H04B 13/02

(52) U.S. Cl. 340/852

(57) ABSTRACT

A technique includes deploying a monitoring station near the sea surface and on the monitoring station, monitoring a position of a subsurface device as the subsurface device moves in a path between the sea surface and the sea floor. The technique includes communicating an indication of a position of the subsurface device from the monitoring station to a surface vessel.

### BACKGROUND

The invention generally relates to a method and apparatus to track and position electromagnetic receivers.

An electromagnetic survey may be performed for purposes of obtaining an image, or survey, of a subsea well or reservoir. In general, electromagnetic surveying is performed by positioning electromagnetic receivers on the seabed in predetermined locations and then either towing an electromagnetic source antenna above them, in the active CSEM (Controlled Source Electromagnetic) case, or simply using the naturally occurring Magnetotelluric (MT) fields as an excitation source for the survey.

In the CSEM case, the source antenna typically has two or more electrodes that are used to excite an electromagnetic field that penetrates the subsurface that is to be surveyed. These operations typically are carried out in waters deeper than 500 meters to minimize the disturbance of the electromagnetic field by the air layer (i.e., the atmosphere) above the sea. A positioning system typically is needed to both correctly position the receivers and to control the tow of the source antenna, which ideally should be towed through the water in a pattern at a specified altitude above and parallel to the sea bed, typically between an altitude of thirty to and altitude of fifty meters.

In the MMT (Marine MT) case, the naturally occurring MT fields penetrate the earth beneath the sea bottom and the electromagnetic receivers record the total field corresponding to the incident MT field plus the earth response field.

The electromagnetic receivers typically are deployed from a surface vessel. In this regard, the receivers typically are deployed at the sea surface and descend through the water to target positions on the sea bed. Because the operations to deploy the electromagnetic receivers typically occur in deep water (water greater than approximately 500 meters, for example), there is normally an element of probing with a first receiver to measure the horizontal drift due to sea water currents so that subsequent receiver drop positions may be offset accordingly. Each of the receivers may descend at a relatively slow velocity, such as a velocity around one meter per second or less, which means it may take a substantially long time for the receiver to reach the bottom.

A conventional positioning technique used today in connection with the electromagnetic receivers involves the use of an ultra short baseline (USBL) system, which is located on the surface vessel that deploys the receivers. The USBL system typically includes an acoustic source and receiver system that is located on the vessel and a transponder that is attached to the electromagnetic receiver being deployed.

Typically, it is important to track the electromagnetic receiver continuously to ensure it does not get lost, which means that the deployment vessel has to remain above the receiver site through the period in which the receiver descends without being able to continue the deployment of other electromagnetic receivers until the first receiver has reached the sea bottom. The receiver locations may be separated by as much as a few kilometers. Therefore, if the vessel moves onto the next receiver site, the vessel may not be able to continue tracking of the descending receiver.

Thus, there exists a continuing need for a better technique and/or apparatus to monitor and position electromagnetic receivers as they are deployed for conducting an electromagnetic survey

### SUMMARY

In an embodiment of the invention, a technique includes deploying a monitoring station near the sea surface and on the monitoring station, monitoring a position of a receiver as the receiver moves in a path between the sea surface and the sea floor. The technique includes communicating an indication of a position of the receiver from the monitoring station to a surface vessel.

Advantages and other features of the invention will become apparent from the following drawing, description and claims.

### BRIEF DESCRIPTION OF THE DRAWINGS

FIGS. 1, 2 and 3 are schematic diagrams illustrating the deployment and tracking of electromagnetic receivers according to different embodiments of the invention.

FIG. 4 is a flow diagram depicting a technique to deploy at least one receiver according to an embodiment of the invention.

FIG. 5 is a flow diagram depicting a technique to retrieve and track a surfaced electromagnetic receiver according to an embodiment of the invention.

FIG. 6 is a schematic diagram of an electromagnetic receiver according to an embodiment of the invention.

### DETAILED DESCRIPTION

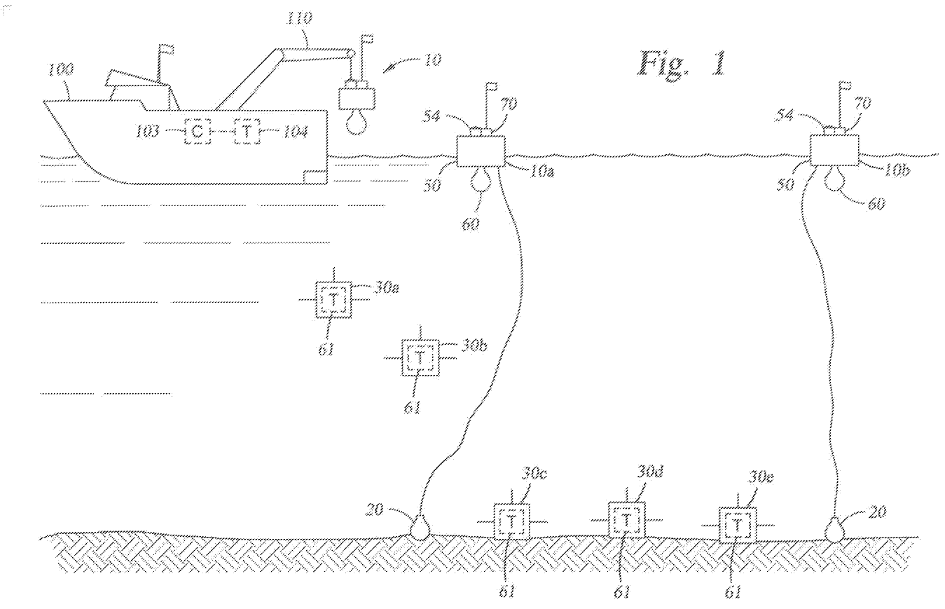

Referring to FIG. 1, in accordance with some embodiments of the invention, floating buoy-based monitoring stations 10 (monitoring stations 10a and 10b, being depicted in FIG. 1, as examples) are used to monitor the deployment of electromagnetic receivers (electromagnetic receivers 30a, 30b, 30c, 30d and 30e, collectively references as 30, being depicted in FIG. 1 as examples) from the sea surface to the sea floor. After being deployed to the sea floor, the electromagnetic receivers 30 may be used for purposes of conducting an electromagnetic survey, such as for purposes of measuring electromagnetic fields that are generated in response to a towed electric dipole or MT fields.

Each monitoring station 10 is equipped with a position receiver 60, which monitors transmissions that are generated by transponder(s) 61 of one or more of a group of the electromagnetic receivers 30 that are assigned to the monitoring station 10 for purposes of tracking the positions of the electromagnetic receiver(s) 30 as the electromagnetic receiver(s) 30 descend to the sea floor and for determination of their positions where they rest on the seafloor. For example, the monitoring station 10a may track the positions of the electromagnetic receivers 30a, 30b and 30c; and the monitoring station 10b may track the positions of the electromagnetic receivers 30d and 30e. The position of a particular electromagnetic receiver 30 may be given by, for example, the range, bearing and elevation of the electromagnetic receiver 30; and all of these coordinates may be obtainable via the information that is obtained via the monitoring station's position receiver 60.

In one example, a position receiver 60 is an acoustic receiver that monitors the position of an electromagnetic receiver 30 based on acoustic signals generated by the transponder 61 on the electromagnetic receiver. In another example, the position receiver 60 and the transponder may use radio frequency transmissions. Other examples of a position receiver 60 and a transponder 61 may be used without departing from the scope of the present invention. In addition, it is possible to combine a position receiver and transponder on both the monitoring station and the electromagnetic receivers. In such a case, two-way communication may be achieved between the monitoring station and an electromagnetic receiver.

In accordance with some embodiments of the invention, each monitoring station 10 also includes a transmitter (not shown) to interrogate a corresponding position receiver (not shown) of the electromagnetic receiver 30, which senses the interrogation by the transmitter of the monitoring station 10. Thus, in accordance with some embodiments of the invention, both the monitoring stations 10 and the electromagnetic receivers 30 each includes a transmitter/receiver pair for purposes of tracking the positions of the electromagnetic receivers 30. Each transmitter/receiver pair may be integrated on the same head, in accordance with some embodiments of the invention.

In accordance with some embodiments of the invention, each of the monitoring stations 10 may also include a global navigation satellite (GNSS) subsystem 54 for purposes of acquiring a globally referenced position (i.e., coordinates referenced to WGS-84 datum or an ITRF, International Terrestrial Reference Frame) of the monitoring station 10 using any of the many positioning methods available with GNSS; and each of the monitoring stations 10 may include a wireless telemetry system 70 for purposes of communicating the position of the monitoring station 10 as well as the positions of the electromagnetic receivers 30 that are assigned to the station 10 back to a surface vessel 100. Alternatively, the monitoring station 10 may contain positioning devices other than a GNSS subsystem, in accordance with other embodiments of the invention. Examples of such are terrestrial radio navigation systems (i.e. Loran C, Microfix), passive or active radar reflectors facilitating positioning from the surface vessel or other station using the radar, or optical prisms that can be used with a laser or an electro-optical measuring system in a similar way.

Due to the use of the monitoring stations 10, the electromagnetic receivers 30 may be deployed from the surface vessel 100 and monitored, or tracked, in the following manner. First, from the surface vessel 100, a group of one or more electromagnetic receivers 30 are deployed at the sea surface (via a crane or boom 110 of the surface vessel 100, for example) into the sea, along with an associated floating monitoring station 10 that is configured to track the descent and final location of the electromagnetic receivers 30 of the group. It is noted that each monitoring station 10 may be secured to the seabed via an associated anchor 20. In another example, it may be preferable to use a sea anchor instead of a seabed anchor in deep water. Thus, after being deployed, the electromagnetic receiver(s) 30 descend to the sea bed, while the associated monitoring station 10 floats on the sea surface, while being held in the same general location via the anchor tether.

Each monitoring station 10 acquires its own position from its onboard GNSS subsystem 54. Furthermore, each monitoring station 10 is aware of the relative positions of the tracked electromagnetic receivers 30 due to the position receiver 60 (of the monitoring station 10) and the transponders 61 (of the monitored electromagnetic receivers 30). The monitoring station 10 may wireless communicate (via a wireless telemetry interface 70 of the monitoring station 10) the position of the station 10 and the positions of the monitored electromagnetic receivers 30 to the surface vessel 100 so that the positions of the electromagnetic receivers 30 may be monitored from onboard the surface vessel 100.

More specifically, the surface vessel 100 may include a wireless telemetry interface 104 that receives wireless communications from the telemetry interfaces 70 of the monitoring stations 10. The telemetry interface 104 may, for example, communicate received data, which indicates the receiver positions, to an onboard computer 103 of the surface vessel 100. As an example, the onboard computer 103 may execute software to calculate and display the positions of the electromagnetic receivers 30 so that these positions may be monitored by an operator who is onboard the surface vessel 100.

In accordance with some embodiments of the invention, each position receiver 60-transponder 61 pair is an independent ultra short baseline (USBL) communication system that permits the tracking of the altitude and azimuth and range to the electromagnetic receiver 30. As a more specific example, in accordance with some embodiments of the invention, the USBL communication system is a Global Acoustic Positioning System (GAPS), which is available from iXSea. The GAPS includes an inertial platform that is integrated with the sensor head so that the orientation of it can be accurately monitored without external sensors or measurements. The GAPS is factory-calibrated so that the alignment of the inertial platform axes with the transducer head axes is known. Alternative instrumentations may make use of other acoustic positioning systems co-located with a suitable external inertial platform, but then the alignment of the systems has to be determined explicitly.

As noted above, a single monitoring station 10 may be assigned to one or more of the electromagnetic receivers 30. The number of electromagnetic receivers 30 tracked by a single monitoring station 10 may be a function of the distances between seabed receiver sites and/or the water depth and/or transponder directivity. In accordance with some embodiments of the invention, the receiver-to-monitoring station assignments may be dynamic in nature, so that when a particular receiver 30 is out of range from its originally-assigned monitoring station 10, or better accuracy or update rate may be achieved using another one, another monitoring station 10 may be reassigned to track this receiver 30.

The receiver-to-monitoring station assignments and assignment changes may be directed via communications from the surface vessel computer 103, may be directed via communications among the monitoring stations 10, or may involve a combination of these mechanisms, depending on the particular embodiment of the invention.

For example, in some embodiments of the invention, a human operator onboard the surface vessel 100 may, based on communications from the monitoring stations 10, determine that one of the electromagnetic receivers 30 is too far away from its assigned monitoring station 10. The determination may be based on the monitoring station's inability to acquire the position of the affected receiver or the affected receiver and the monitoring station 10 being separated by a calculated distance (as determined by the computer 103, for example) that exceeds a distance threshold.

The determination of whether a particular receiver 30 is too far away from its assigned monitoring station 10 may also be performed automatically by the computer 103, in accordance with other embodiments of the invention. Once it is determined that the assignment needs to be changed, a human operator or the computer 103 may then signal the appropriate monitoring stations 10 to make the corresponding assignment changes.

Alternatively, the need for assignment changes as well as the assignment changes themselves may be handled automatically via communications among the deployed monitoring stations 10.

As an example of another embodiment of the invention, two or more monitoring stations may each be assigned to track all or a common subset of the electromagnetic receivers 30 in parallel. Thus, many variations are possible and are within the scope of the appended claims.

When the electromagnetic receivers 30 have reached the sea bottom and their final, resting positions have been determined, the surface vessel 100 may then pick up the monitoring stations 10 so that the stations 10 may be reused to assist in the tracking of other electromagnetic receivers 30. In accordance with some embodiments of the invention, a second vessel may be used to assist with picking up the monitoring stations 10. In one example, the second vessel is smaller than the surface vessel 100, and it is configured to deploy and retrieve monitoring stations 10. It is noted that in accordance with some embodiments of the invention, it may be advantageous to have a sufficient number of monitoring stations 10 to cover the entire deployment so that extra rounds with the smaller vessel may be avoided.

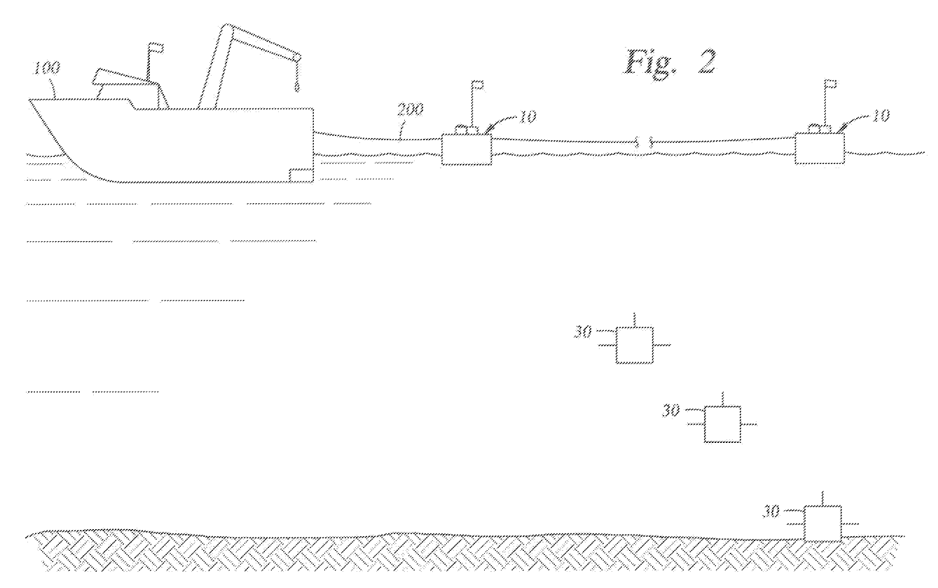

Other embodiments are possible and are within the scope of the appended claims. For example, in accordance with some embodiments of the invention, the monitoring stations 10 may be coupled together and towed behind the surface vessel 100 on a tow line 200, as depicted in FIG. 2.

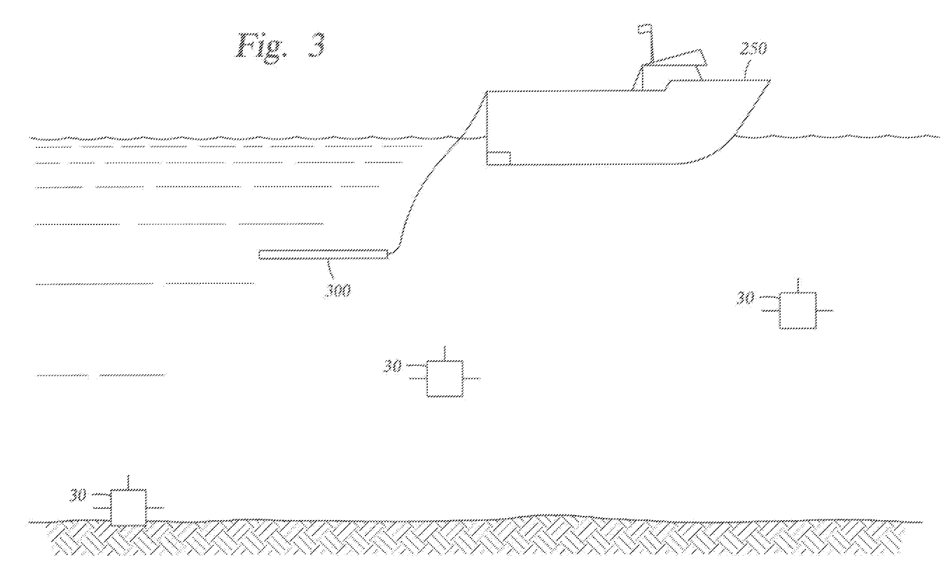

As another example of an alternative embodiment of the invention, a near surface vehicle may be used in place of one or more of the buoy-based monitoring stations 10 of FIGS. 1 and 2. Referring to FIG. 3, in this regard, in accordance with some embodiments of the invention, a near surface vessel 250 may be controllable from the surface vessel 100 (see FIGS. 1 and 2) for purposes of guiding the near surface vessel 250 in the vicinity of the electromagnetic receivers 30 that are being monitored by the surface vessel 250.

The surface vessel 250 may, for example, tow a streamer that includes an array 300 for purposes of monitoring and positioning the assigned electromagnetic receivers 30. In accordance with some embodiments of the invention, a long baseline (LBL) system may be used in connection with the surface vehicle 250 to monitor the deployed electromagnetic receivers 30.

The LBL system may be also used in conjunction with one of the techniques that are depicted in FIGS. 1 and 2 in accordance with other embodiments of the invention. In this regard, instead of using an USBL system, the monitoring stations 10 and electromagnetic receivers 30 may form a LBL-based system. In an LBL system, each monitoring station alternatively has an acoustic receiver, and the monitored receivers have acoustic transmitters. For this type of arrangement, the receiver positions are determined via triangulation, so that at least three monitoring stations 10 are positioned in a triangle for purposes of determining receiver positions. The surface vessel 100 itself may be one of the monitoring stations.

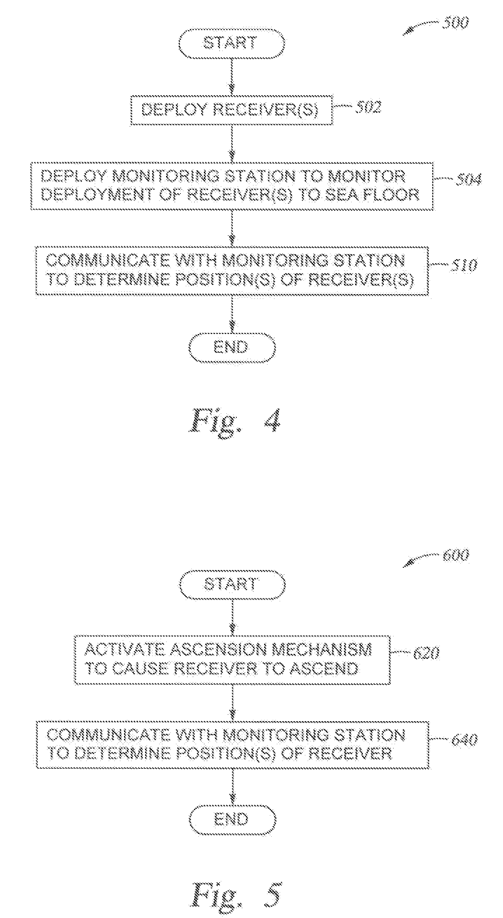

Referring to FIG. 4, to summarize, in accordance with some embodiments of the invention, a technique 500 may be generally used to track the position of electromagnetic receivers. Pursuant to the technique 500, the receivers are deployed, pursuant to block 502. Next, a monitoring station is deployed (block 504) to monitor the deployment of the receiver(s) to the sea floor. The order in which the monitoring station 10 and electromagnetic receivers 30 are deployed may be reversed (should it be more practical), in accordance with other embodiments of the invention. The technique 500 includes communicating (block 510) with the monitoring station to determine the position(s) of the receiver(s), pursuant to block 510.

After the receivers are deployed on the sea bed and used for purposes of performing an electromagnetic survey, the electromagnetic receivers 30 may then be retrieved. More specifically, in accordance with some embodiments of the invention, each receiver 30 may include an acoustically-activated mechanism that causes the receiver 30 to ascend to the sea surface.

In one example, when a particular receiver 30 is to be retrieved from the sea floor, acoustic waves may be communicated from a surface vessel to the receiver 30. In response to this communication, the receiver 30 may activate a surfacing mechanism (a mechanism to cause the receiver 30 to discharge ballast tanks, for example), which causes the receiver 30 to ascend to the sea surface. In another example, the receiver 30 may include a burn wire that is severed using electrical current in the seawater environment upon receiving the surface command.

The ascension of the electromagnetic receivers 30 may be monitored by monitoring stations, similar to the monitoring stations described above. Without this monitoring, the positions of the electromagnetic receivers 30, once surfaced, may be difficult to determine. The ascent of the receiver 30 may take a significantly longer time than its descent, according to some embodiments of the invention.

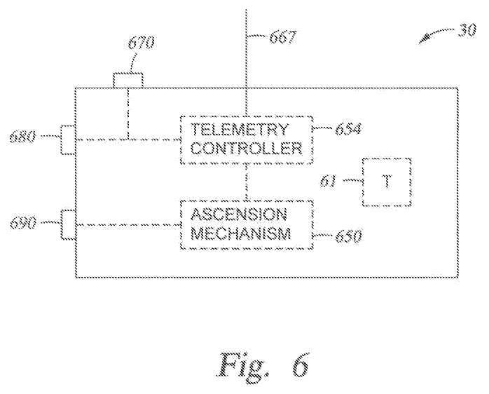

Referring to FIG. 6, in accordance with some embodiments of the invention, in addition to the transponder 61, various antennae (not shown) and subsystems (not shown) for making electromagnetic measurements, the receiver 30 may also include features that aid in retrieving the receiver 30. These features include a GNSS subsystem 670 and a wireless telemetry subsystem (an antenna 667 and a telemetry controller 654), which are activated in response to the receiver 30 surfacing. More specifically, in accordance with some embodiments of the invention, the receiver 30 includes an acoustic sensor 690 that is coupled to an ascension mechanism 650, which is activated (via acoustic waves that may be communicated via the surface vessel 100 to the sensor 690, for example) for purposes of increasing the buoyancy of the receiver 30 to cause the receiver 30 to surface. The receiver 30 may also include a surfacing detection sensor 680 (a sensor that detects air, for example) that is coupled to the telemetry controller 654 and to the GNSS subsystem 670 for purposes of activating the GNSS and telemetry subsystems when the receiver 30 surfaces. The position is then telemetered to the surface vehicle 100 or 250 either directly or through a relay station. The formerly explained monitoring buoy may also work as a relay for the telemetry should need be. As an alternative or additional positioning device to assist in locating the surfaced receiver one may use a radio beacon, a passive or active radar reflector, an optical reflector, or other devices to assist in direction finding or other method of homing.

Referring to FIG. 5, to summarize, in accordance with some embodiments of the invention, a technique 600 includes activating (block 620) an ascension mechanism to cause an electromagnetic receiver to ascend to the sea surface and causing the receiver to communicate (block 640) with a monitoring station so that the pickup position of the receiver may be determined.

It will be appreciated by persons having ordinary skill in the art that while the above description relates to the deployment and positioning of electromagnetic receivers, the invention may be practiced in connection with any subsurface device to be positioned below the surface of the sea, including on the sea floor. For example, a monitoring station may be used to monitor the descent of a seismic sensor or receiver to be located on the seafloor.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

1. A method comprising:
deploying a monitoring station near the sea surface;
on the monitoring station, monitoring a position of a subsurface device as the subsurface device moves in a path between the sea surface and a sea floor, and
communicating an indication of a position of the subsurface device from the monitoring station to a surface vessel.

2. The method of claim 1, wherein the subsurface device comprises an electromagnetic receiver.

3. The method of claim 2, further comprising:
deploying the receiver at the sea surface so that the receiver descends from the sea surface to the sea floor,
wherein the monitoring comprises monitoring the position of the receiver as the receiver descends from the sea surface.

4. The method of claim 2, further comprising:
activating a mechanism of the receiver to cause the receiver to ascend from the sea floor to the sea surface,
wherein the monitoring comprises monitoring the position of the receiver as the receiver ascends from the sea surface.

5. The method of claim 1, further comprising:
on the monitoring station determining a position of the monitoring station.

6. The method of claim 5, wherein determining the position of the monitoring station comprises using at least one of the following:
a global navigation satellite subsystem, a terrestrial radio navigation system, a passive radar reflector, an active radar reflector and an optical prism.

7. The method of claim 1, further comprising:
on the monitoring station, determining a position of the subsurface device relative to the monitoring station.

8. The method of claim 1, wherein deploying the monitoring station comprises deploying a buoy-based monitoring system.

9. The method of claim 1, wherein deploying the monitoring station comprises deploying a second surface vessel to which the indication is communicated.

10. The method of claim 1, further comprising:
communicating indications of positions of one or more additional subsurface devices from the monitoring station to the surface vessel.

11. A monitoring station to track a subsurface device deployed in the sea, the monitoring station comprising:
a position receiver to monitor a position of the subsurface device as the subsurface device moves in a path between the sea surface and a sea floor; and
a telemetry interface to communicate an indication of a position of the subsurface device from the monitoring station to a surface vessel.

12. The monitoring station of claim 11, wherein the subsurface device comprises an electromagnetic receiver.

13. The monitoring station of claim 11, wherein the monitoring station comprises a buoy.

14. The monitoring station of claim 11, further comprising:
one of the following to acquire a position of the monitoring station:
a global navigation satellite subsystem, a terrestrial radio navigation system, a passive radar reflector, an active radar reflector and an optical prism;
wherein the telemetry interface is further configured to communicate the position of the monitoring station to the surface vessel.

15. The monitoring station of claim 11, wherein the telemetry interface is further configured to communicate indications of positions of one or more additional subsurface devices from the monitoring station to the surface vessel.

16. The monitoring station of claim 11, wherein the indication of the position of the subsurface device comprises a position relative to the monitoring station.

17. The monitoring station of claim 11, wherein the indication of the position of the subsurface device comprises an absolute position.

18. A system comprising:
a surface vessel to deploy a monitoring station and a subsurface device,
wherein the monitoring station is configured to monitor deployment of the subsurface device from the sea surface to the sea bed and communicate an indication of the subsurface device position to the surface vessel.

19. The system of claim 18, wherein the subsurface device comprises an electromagnetic receiver.

20. The system of claim 19, wherein the receiver comprises an ascension system configured to be activated to cause the receiver to ascend from the sea floor; and
a telemetry circuit to communicate a position of the receiver to the surface vessel after the receiver surfaces at the sea surface.

21. The system of claim 18, wherein the monitoring station and the subsurface device form an ultrashort baseline positioning system.

22. The system of claim 18, wherein the monitoring station and the subsurface device form a long baseline positioning system.

23. (canceled)
